(19) United States
(12) Patent Application Publication
(10) Pub. No.: US 2026/0146878 A1
(43) Pub. Date: May 28, 2026

(54) MAGNETIC-INDUCTIVE FLOW MEASURING PROBE

(71) Applicant: Endress+Hauser Flowtec AG, Reinach (CH)

(72) Inventors: Beat Tschudin, Reinach (CH); Thomas Bier, Riehen (CH); Bruno Worreth, Kiffis (FR); Simon Mariager, Basel (CH); Günther Bähr, Therwil (CH); Steffen Weiss, Grenzach-Wyhlen (DE); Sabrina Ulmi, Münchenstein (CH); Eliaz Schmid, Efringen-Kirchen (DE)

(21) Appl. No.: 18/720,028

(22) PCT Filed: Nov. 22, 2022
(86) PCT No.: PCT/EP2022/082773

§ 371 Date: Jun. 14, 2024

(30) Foreign Application Priority Data
Dec. 16, 2021 (DE) 10 2021 133 553.1

(51) Int. Cl. G01F 1/58

(52) U.S. Cl. CPC G01F 1/584; G01F 1/586

(57) ABSTRACT

A magnetic-inductive flow measuring probe includes: a sleeve with a sleeve end portion which makes contact with a medium; at least two measuring electrodes for forming electrically conductive contact with the medium and for tapping of an induced voltage in the flowing medium, wherein at least one of the at least two measuring electrodes is arranged in the sleeve end portion; and a magnetic field-generating device for generating a magnetic field passing through at least the sleeve end portion including: a coil having a coil opening; a field guiding body extending through the coil opening, wherein the field guiding body includes a coil core; and a shielding body arranged between the coil and the at least one of the at least two measuring electrodes, wherein the shielding body is electrically connected to a reference potential.

### CROSS-REFERENCE TO RELATED APPLICATIONS

The present application is related to and claims the priority benefit of German Patent Application No. 10 2021 133 553.1, filed Dec. 16, 2021, and International Patent Application No. PCT/EP 2022/082773, filed Nov. 22, 2022, the entire contents of which are incorporated herein by reference.

### TECHNICAL FIELD

The present disclosure relates to a magnetic-inductive flow measuring probe for insertion into an opening of a tube line through which a flowable medium flows and for determining a flow velocity-dependent measured variable of a flowable medium.

### BACKGROUND

Magnetic-inductive flowmeters are used for determining the flow rate and the volumetric flow of a flowing medium in a tube line. A magnetic-inductive flowmeter has a magnet system that generates a magnetic field perpendicular to the direction of flow of the flowing medium. Single coils are typically used for this purpose. In order to realize a predominantly homogeneous magnetic field, pole shoes are additionally formed and attached such that the magnetic field lines run over the entire tube cross-section substantially perpendicularly to the transverse axis or in parallel to the vertical axis of the measuring tube. A measuring electrode pair attached to the lateral surface of the measuring tube taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate and, with the inclusion of a known tube cross-section, the volumetric flow can be determined from the induced measurement voltage.

In contrast to a magnetic-inductive flowmeter, which comprises a measuring tube for guiding the medium with an attached device for generating a magnetic field penetrating the measuring tube and measuring electrodes, magnetic-inductive flow measuring probes with their metallic sleeve enclosing the measuring electrodes and the magnetic field-generating device are inserted into a lateral opening of a tube line and fixed in a fluid-tight manner. A measuring tube is no longer necessary. The measuring electrodes and device for generating the magnetic field penetrating the measuring tube, mentioned in the introduction, on the lateral surface of the measuring tube are omitted and are replaced by a device for generating the magnetic field arranged inside the sleeve and in direct proximity to the measuring electrodes, which is designed such that an axis of symmetry of the magnetic field lines of the generated magnetic field perpendicularly intersects the front surface or the surface between the measuring electrodes. In the prior art, there is already a plurality of different magnetic-inductive flow measuring probe. EP 0 892 251 A1, for example, teaches a magnetic-inductive flow measuring probe with a front plate closing the housing at the end-which is designed as a spherical cap-and a device arranged in the housing for generating a magnetic field passing through the front plate. The device comprises a coil that is slid onto a cylindrical coil core, which acts as a coil carrier, and field return bodies. Two pin-shaped measuring electrodes are fastened in the front panel and are covered by the device for generating the magnetic field in the longitudinal direction of the housing. In addition to the sleeve, magnetic-inductive-flow measuring probes usually have a housing formed from plastic, in which the electronic components for operating the magnetic-inductive flow measuring probe are arranged. With such magnetic-inductive flow measuring probes, it has been found that the zero point error increases significantly as the compactness of the components arranged inside the sleeve for determining the flow velocity-dependent measured variable increases.

### SUMMARY

The object of the present disclosure is to remedy this.

The object is achieved by the magnetic-inductive flow measuring probe according to the present disclosure.

The magnetic-inductive flow measuring probe according to the present disclosure for insertion into an opening of a container through which a flowable medium flows and for determining a flow velocity-dependent measured variable of a flowable medium, comprises:
a sleeve with a sleeve end portion which makes contact with a medium,
at least two measuring electrodes for forming electrically conductive contact with the medium and for tapping of an induced voltage in the flowing medium,
   wherein at least one of the at least two measuring electrodes is arranged in the sleeve end portion;
a magnetic field-generating device for generating a magnetic field penetrating at least the sleeve end portion, comprising:
   a coil with a coil opening;
   a field guiding body which extends at least in portions through the coil opening, wherein the field guiding body comprises a coil core; and
   a shielding body which is arranged at least between the coil and the at least one measuring electrode,
   wherein the shielding body is electrically connected to a reference potential.

The measuring arrangement in a process plant according to the present disclosure comprises:
a container, in particular a tube line, for guiding a medium with an opening in a lateral surface;
a magnetic-inductive flow measuring probe according to the present disclosure, which is arranged in the opening.
   The shielding body can be realized as a flexible copper foil, which is wrapped around the coil or as a comparatively solid sleeve that is pushed onto the coil. Through the provision of a shielding body, the crosstalk between the coil and the at least one measuring electrode or the corresponding measuring electrode plug connection on the printed circuit board, and thus a stable zero point, can be achieved.
   Advantageous embodiments of the present disclosure are the subject matter of the dependent claims.

One embodiment provides that the field guiding body comprises at least one field return body,
wherein the shielding body is in operative connection with the at least one field return body.

One embodiment provides that the at least one field return body is electrically connected to the reference potential, in particular via a plug connection.

One embodiment provides that the shielding body is connected to the at least one field return body with a material bond, at least in portions.

The shielding body can be connected separately to the electrical reference potential, for example by means of a clamp connection. However, it is more advantageous if the shielding body is in operative connection with the field return body, which itself is connected to the reference potential, for example by means of a plug connection, since this provides a more stable solution in terms of mechanics and measurement technology. The reference potential can be the ground potential, for example.

One embodiment provides that the shielding body encloses the coil and the coil core in at least one cross-section of the magnetic field-generating device.

One embodiment provides that at least in each cross-section of the coil in which a coil plane intersects at least one of the measuring electrodes, the corresponding coil plane also intersects the shielding body.

One embodiment provides that the shielding body completely covers an outer surface of the coil, in particular two-thirds and preferably one-third.

Complete masking of the coil by the shielding body results in a stable zero point. Surprisingly, however, it has been found that a stable zero point can be realized with a masking of two-thirds or, in certain applications, with a masking of one-third.

One embodiment provides that the shielding body is designed to be hollow-cylindrical, at least in portions.

One embodiment provides that the shielding body is formed by a sheet metal part, in particular a cylindrically bent sheet metal part, in particular with a cross-section that is at arc-shaped at least in portions.

One embodiment provides that the shielding body is designed in two parts.

One embodiment provides that the shielding body, in particular in an edge region, has at least one outwardly bent sub-region,
wherein the at least one sub-region rests on a contact surface, in particular a planar contact surface, of the at least one field return body.

One embodiment provides that the magnetic field-generating device comprises two field return bodies.

One embodiment provides that the shielding body has, in particular in an edge region, at least two outwardly bent sub-regions,
wherein the two sub-regions in each case rest on a contact surface, in particular a planar contact surface, of one of the two field return bodies.
   The advantage of the embodiment is the simplified connectability of the shielding body to the field return bodies and at the same time the improved electrical connection of the shielding body to the electrical reference potential.

One embodiment provides that the field guiding body is designed to be monolithic.

One embodiment provides that the shielding body has a lateral surface,
wherein a distance between a point on the lateral surface and one of the at least two measuring electrodes is less than 10 mm, in particular less than 5 mm and preferably less than 1 mm.
   The advantage of the embodiment is the compactness of the arrangement of the individual components for determining the flow velocity-dependent measured variable while maintaining a stable zero point.

One embodiment provides that the shielding body is formed from a (steel or brass) sleeve.

Steel sleeves are more suitable than brass sleeves for the material-bonded connection with the field return body. In view of the assembly of the individual components of the magnetic-inductive flow measuring probe, the use of sleeves instead of foils is more advantageous.

One embodiment provides that the shielding body has a wall thickness of 0.3 mm to 0.1 mm.

Due to the very low wall thickness of the shielding body, a very compact magnetic field-generating device can be realized without having to forego windings at the same time.
Another advantage is that the shielding body is easier to machine, in particular for the production of the cut-out and bent sub-regions. At the same time, reasonable welding resistances are still possible in the wall thickness range.

### BRIEF DESCRIPTION OF THE DRAWINGS

The present disclosure is explained in greater detail with reference to the following figures. In the figures:

FIG. 1 shows a perspective view of a partially cut magnetic-inductive flow measuring probe;

FIG. 2 shows the inner workings of the magnetic-inductive flow measuring probe;

FIG. 3 shows a further embodiment of the shielding body; and

FIG. 4 shows a measuring arrangement according to the present disclosure.

### DETAILED DESCRIPTION

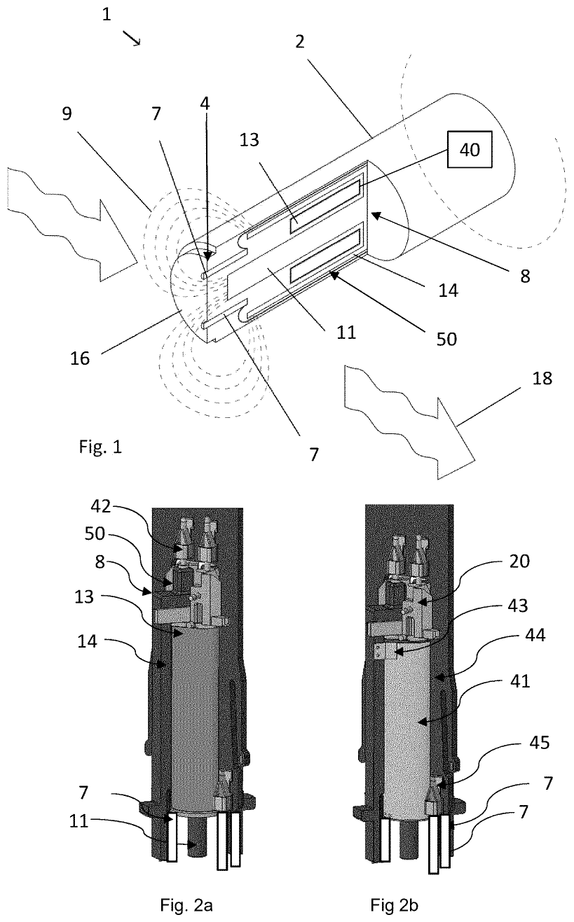

First, the measuring principle on which the present disclosure is based is explained on the basis of the perspective and partially sectional illustration of FIG. 1. A magnetic-inductive-flow measuring probe 1 for insertion into an opening of a container through which a flowable medium flows and for determining a flow velocity-dependent measured variable of a flowable medium comprises a generally hollow and circular cylindrical sleeve 2 having a predetermined outer diameter and that is usually made of metal. This is adapted to the diameter of a bore, which is located in a wall of a tube line 26, not shown in FIG. 1 but in FIG. 5, and into which the magnetic-inductive flow measuring probe 1 is inserted in a fluid-tight manner. A flowable medium to be measured flows in the tube line 26 and the flow measuring probe 1 is immersed into said medium practically perpendicularly to the flow direction of the medium, which is indicated by the wavy arrows 18. A sleeve end portion 4 of the sleeve 2 that protrudes into the medium and comes into contact with the medium is sealed in a fluid-tight manner with a front body 16 made of insulating material. By means of a magnetic field-generating device 8 arranged at least in portions in a sleeve interior 10 of the sleeve 2, a magnetic field 9 reaching through the sleeve end portion 4 into the medium can be generated. A coil core 11, which at least partially consists of a soft magnetic material and is arranged in the sleeve 2, terminates at or near the sleeve end portion 4. A field return with a field return body 14, which encloses a coil 13 and the coil core 11 at least in portions, is configured to feed the magnetic field 9 passing through from the sleeve end portion 4 back into the sleeve 2 to the coil core 11. Two galvanic measuring electrodes 7 are arranged in the front body 16 and are in contact with the medium. An electrical voltage induced due to Faraday's law of induction can be tapped at the measuring electrodes 7 by means of a measuring circuit. This is at a maximum if the magnetic-inductive flow measuring probe 1 is installed in the tube line such that a plane spanned by a straight line intersecting the two measuring electrodes 7 and a longitudinal axis of the magnetic-inductive flow measuring probe 1 runs perpendicularly to the flow direction 18 or longitudinal axis of the tube line. More than two measuring electrodes 7 can also be provided. Such variants are used, for example, for more precise conductivity measurement or for flow direction detection. An operating circuit 40 is electrically connected to the coil 13, and is configured to impress a clocked excitation signal to the coil 13 in order to thus generate a clocked magnetic field 9.

FIG. 2 shows the inner workings of the magnetic-inductive flow measuring probe according to the present disclosure. The magnetic field-generating device 8 for generating the magnetic field penetrating at least the sleeve end portion comprises a coil 13 with a coil opening. The coil 13 comprises a coil body 20, in which the coil opening is also located, and a coil winding that comprises at least one coil wire that is wound around the coil body 20. Furthermore, the magnetic field-generating device 8 comprises a field guiding body 50, which extends at least in portions through the coil opening. The field guiding body 50 is designed to be monolithic and comprises a coil core 11 and two field return bodies 14. The field guiding body 50 can be realized as a MIM (metal injection molding) component, a cast part or as a component made of stamped electrical sheets.

One part of the magnetic field-generating device is the shielding body 41, which is arranged at least between the coil 13 and the at least one measuring electrode 7 and is configured to reduce or prevent crosstalk from the coil to the measuring electrode. For this purpose, the shielding body 41 is electrically connected to a reference potential. This is realized by the shielding body 41 being in operative connection with the at least one field return body 14, which is electrically connected to the reference potential via a plug connection 42. Furthermore, it is advantageous if, at least in each cross-section of the coil 13 in which a coil plane intersects at least one of the measuring electrodes 7, the corresponding coil plane also intersects the shielding body 41. Furthermore, it is advantageous if the shielding body 41 completely covers an outer surface of the coil 13, in particular two-thirds and preferably one-third. According to the illustrated embodiment, the shielding body 41 is connected to the at least one field return body 14 with a material bond, at least in portions. The materially bonded connection is made via two cut-out and outwardly bent sub-regions 43 in the edge region of the shielding body 41, which in each case rests on a contact surface, in particular a planar contact surface, of one of the two field return bodies 14 and is welded there. The shielding body 41 encloses the coil 13 and the coil core 11 in at least one cross-section of the magnetic field-generating device 8. For this purpose, it is designed to be cylindrical, at least in portions. Furthermore, the smallest distance between a point on the lateral surface of the shielding body 41 and one of the at least two measuring electrodes 7 is less than 10 mm, in particular less than 5 mm and preferably less than 1 mm. In order to realize a high coil winding, the shielding body 41 has a wall thickness of 0.3 mm to 0.1 mm. The shielding body 41 in FIG. 2 is designed as a sleeve comprising brass and/or steel.

The measuring electrodes 7 are electrically connected to the measuring circuit by means of measuring electrode plug connections 45 arranged on the printed circuit board 44. The longitudinal axes of the measuring electrodes run parallel to the longitudinal axis of the coil core 11 or the magnetic field-generating device 8.

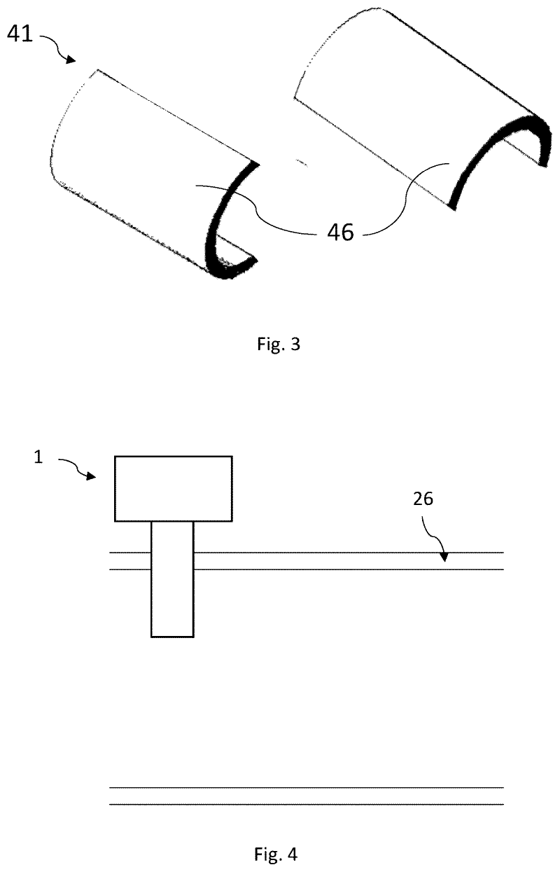

FIG. 3 shows a further embodiment of the shielding body 41, which substantially differs from the embodiment of FIG. 2 in that the shielding body 41 is formed by two sheet metal parts 46, in particular cylindrically bent sheet metal parts, in particular with cross-sections that are arc-shaped at least in portions.

Alternatively, the shielding body 41 can also be formed from only one of the two sheet metal parts shown.

FIG. 4 shows a measuring arrangement according to the present disclosure in a process plant, which comprises a tube line 26 for guiding a medium. The tube line 26 has an opening that is incorporated laterally in a lateral surface. A magnetic-inductive flow measuring probe 1 according to the present disclosure is arranged in the opening and is configured to determine and monitor a flow velocity-dependent measured variable.

1-17. (canceled)

18. A magnetic-inductive flow measuring probe for insertion into an opening of a process container through which a flowable medium flows and for determining a flow velocity-dependent measured variable of the medium, the flow measuring probe comprising:
a sleeve with a sleeve end portion configured to contact the medium;
at least two measuring electrodes, each configured to effect galvanic contact with the medium and to tap an induced voltage in the flowing medium, wherein at least one of the at least two measuring electrodes is disposed in the sleeve end portion; and
a magnetic field-generating device configured to generate a magnetic field passing through at least the sleeve end portion, the magnetic field-generating device comprising:
a coil with a coil opening;
a field guiding body which extends, at least in portions, through the coil opening, wherein the field guiding body includes a coil core; and
a shielding body, which is arranged at least between the coil and the at least one of the at least two measuring electrodes, wherein the shielding body is electrically connected to a reference potential.

19. The magnetic-inductive flow measuring probe according to claim 18, wherein the field guiding body includes at least one field return body, wherein the shielding body is operatively connected with the at least one field return body.

20. The magnetic-inductive flow measuring probe according to claim 18, wherein the shielding body encloses the coil and the coil core in at least one cross-section of the magnetic field-generating device.

21. The magnetic-inductive flow measuring probe according to claim 20, wherein the shielding body is cylindrical, at least in portions.

22. The magnetic-inductive flow measuring probe according to claim 18, wherein the shielding body is formed of a substantially cylindrically bent sheet metal part with a circular arc-shaped cross-section at least in sections.

23. The magnetic-inductive flow measuring probe according to claim 18, wherein the shielding body is configured in two parts.

24. The magnetic-inductive flow measuring probe according to claim 18, wherein the shielding body is connected to the at least one field return body with a material bond, at least in portions.

25. The magnetic-inductive flow measuring probe according to claim 24, wherein the at least one field return body is electrically connected to the reference potential via a plug connection.

26. The magnetic-inductive flow measuring probe according to claim 25, wherein, in an edge region, the shielding body includes at least one outwardly bent sub-region,
wherein the at least one sub-region rests on a contact surface of the at least one field return body.

27. The magnetic-inductive flow measuring probe according to claim 18, wherein the magnetic field-generating device includes two field return bodies.

28. The magnetic-inductive flow measuring probe according to claim 27, wherein, in an edge region, the shielding body includes at least two outwardly bent sub-regions,
wherein each sub-region rests on a contact surface of one of the two field return bodies.

29. The magnetic-inductive flow measuring probe according claim 18, wherein the field guiding body is monolithic.

30. The magnetic-inductive flow measuring probe according to claim 18, wherein, at least in each cross-section of the coil in which a coil plane intersects at least one of the measuring electrodes, the corresponding coil plane also intersects the shielding body.

31. The magnetic-inductive flow measuring probe according to claim 18, wherein the shielding body includes a lateral surface,
wherein a smallest distance between a point on the lateral surface and one of the at least two measuring electrodes is less than 10 mm.

32. The magnetic-inductive flow measuring probe according to claim 18, wherein the shielding body includes a lateral surface,
wherein a smallest distance between a point on the lateral surface and one of the at least two measuring electrodes is less than 1 mm.

33. The magnetic-inductive flow measuring probe according to claim 18, wherein the shielding body completely covers an outer surface of the coil.

34. The magnetic-inductive flow measuring probe according to claim 18, wherein the shielding body covers two-thirds of an outer surface of the coil.

35. The magnetic-inductive flow measuring probe according to claim 18, wherein the shielding body covers one-third of an outer surface of the coil.

36. The magnetic-inductive flow measuring probe according to claim 18, wherein the shielding body is formed from a brass or steel sleeve.

37. The magnetic-inductive flow measuring probe according to claim 18, wherein the shielding body has a wall thickness of 0.3 mm to 0.1 mm.
